(19) United States
(12) Patent Application Publication
(10) Pub. No.: US 2002/0026449 A1
(43) Pub. Date: Feb. 28, 2002

(54) Method of content driven browsing in multimedia databases

(75) Inventor: Robert Azencott, Paris (FR)

Correspondence Address: McDERMOTT, WILL & EMERY, 600 13th Street, N.W., Washington, DC, 20005-3096, US

(73) Assignee: Sudimage

(21) Appl. No.: 09/783,621

(22) Filed: Feb. 15, 2001

(30) Foreign Application Priority Data
Aug. 29, 2000 (EP) 00410103.6

(51) Int. Cl. G06F 7/00

(52) U.S. Cl. 707/104.1; 707/10

(57) ABSTRACT

A method of content driven browsing in a database including a large number of documents, that can be broken up into elements, each element being described by a state or a value of a same technical characteristic, including the steps of:

a) analyzing the general distribution of the values taken by said technical characteristic over all elements of all documents of the database, to form a sufficiently representative family, which is however of reduced size, of prototype values for said technical characteristic;

b) forming based on each document of the database a vector, each coordinate of which corresponds to a prototype value of said characteristic, the value of each coordinate of the vector corresponding to the frequency of occurrence of said prototype value in the document;

c) determining the distances between the vectors of the various documents of the database; and

d) associating with each document a list of the closest documents for said characteristic.

The present invention relates to a method for managing multimedia databases and more specifically to a method of content driven browsing in multimedia databases. Such databases include digitized documents such as texts, images, video, sound recordings (music or voice), pages, etc., and can be installed on hard disks of personal computers or of computer servers.

Currently available database management systems such as ORACLE, INFORMIX, etc. enable structuring these databases from a logic point of view, and installing standard access interfaces to these bases. Typically, such standard access interfaces enable responding to users search requests via Internet or Intranet transmission networks. For example, the user of such methods may explicitly mention authors, types of documents, and publication periods of interest to him. Standard database management system engines then enable sending back to the user documents in accordance with his request.

To facilitate the exploring of large text databases, various computerized search engines have been commercialized, such as ALTAVISTA. Such engines work on the assumption that an arbitrary text, after an automated analysis of some morpho-syntactical aspects, can be automatically indexed based on all its various semantic contents, most often represented by keywords, or else by all the significant words in the text. Any textual request, written in free language by a user, can be analyzed by the search engine, which browses through all the indexed texts, to find the texts corresponding to the semantic content of the request.

To extend this approach to document bases of other types (such as photographs or images, for example), presently the most current method consists of associating with each document very structured descriptive sheets, listing for example the author, the title, the source, the date, etc. Additional functionalities are then integrated to the textual search engines so that the content of the textual request can be automatically compared to the descriptive text of each document. Establishing the descriptive texts requires the intervention of human operators.

In the two above cases, an explicit textual request of the user enables the search engine to fetch documents from the database. A previous phase of automatic indexing of the documents is essential to guarantee fast on-line searches.

To perform searches in image databases, several computerized image search engines have been commercialized, the best known being VIRAGES and QBIC. The adopted principles are the automatic comparison of the colors present on an image with those present on another image, with an automatic quantization of this difference, to rapidly and automatically search from an electronically indexed database all the images that, as far as colors are concerned, resemble strongly enough a given image chosen on screen by the user of the method.

In current state of the art methods for comparing colors between two images, the principle is to compare two color lists, calculated by computer exploration of two images. The difference between two such lists is calculated by methodically comparing each color in the first list with all those in the second list.

Thus, the state of the art provides relatively simple systems for analyzing and classifying images, which do not lend themselves to a more refined comparative computer indexing of an image database.

On the other hand, current database search methods are based on a semantic definition or other of a request and on a comparison of this definition with each of the database elements, which results in long search durations.

An object of the present invention is to provide a method to generate step by step browsing in image databases, that enables searching images similar to a given image with accuracy and speed.

Another object of the present invention is to provide alternative versions of the content driven circulation and/or search method, adapted to video, sound, or other databases.

The present invention aims at enabling general audience consultation of computer multimedia databases, accessible via Internet, from standard computers (PC provided with Windows NT, for example) provided with a standard commercial browsing software (Internet Explorer, Netscape, or other). These multimedia databases may typically be the elements of an e-commerce catalogue (images and texts), or the iconographic contents and articles of leading monthlies in electronic version, or else the e-commerce catalogue of an audio CD retailer, etc.

More specifically, the present invention provides a method of content driven browsing in a database containing large numbers of documents, by shattering the contents of each document into subparts, each subpart being described by states or values of a technical characteristic, including the steps of:

a) analyzing the general distribution of the values taken by said technical characteristic over all subparts of all documents of the database, to form a sufficiently representative family, which is however of reduced size, of prototype values for said technical characteristic;

b) computing for each document of the database a vector, each coordinate of which corresponds to a prototype value of said characteristic, the value of each coordinate of the vector corresponding to the frequency of occurrence of said prototype value in the document;

c) determining the pairwise distances between the vectors associated to the various documents of the database; and

d) associating with each document a list of the closest documents for said characteristic.

According to an embodiment of the present invention, steps a) to d) are repeated for various technical characteristics that can be associated with the documents of the database and, with each document are associated several lists of the closest documents, each list corresponding to a single one of said characteristics.

According to an embodiment of the present invention, the method includes the step of forming a list of the closest documents, resulting from a weighted combination of the lists corresponding to the various characteristics.

According to an embodiment of the present invention, the documents are images and the forming of said vector includes the steps of:

breaking up each image into a number k of regions (R1 to Rk) homogenous as regards said characteristic and for which the mean value of said characteristic is determined;

determining the relative surface area (S1 to Sk) of each homogenous region;

creating a look-up table of n prototype values (n≧k) of said characteristic sufficiently close to all the observed mean values provided by the whole base of documents;

determining for each mean value (COLj) of each image the number (Mj) of the closest prototype value;

stating G=(M1, M2 . . . Mk);

constructing a vector REPCOL(D)=(RC1 . . . RCn) such that RCi=0 if i does not belong to G and RCi=Sj if i belongs to G and is equal to Mj.

According to an embodiment of the present invention, the characteristics are colors, and said regions have homogenous colors.

According to an embodiment of the present invention, the characteristics are textures, and said regions have homogenous textures.

According to an embodiment of the present invention, the characteristics are shapes, and the shape characteristic of each said region is its external contour, or silhouette.

The foregoing objects, characteristics and advantages, as well as others, of the present invention will be discussed in detail in the following non-limiting description of specific embodiments made in conjunction with the accompanying drawings.

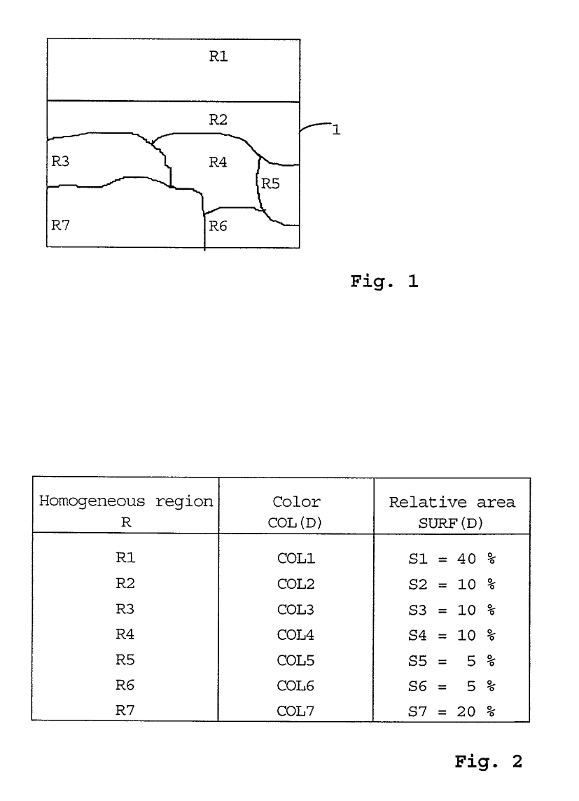

FIG. 1 shows an example of breaking up of an image into homogenous regions;

FIG. 2 shows a table corresponding to the breaking up of FIG. 1; and

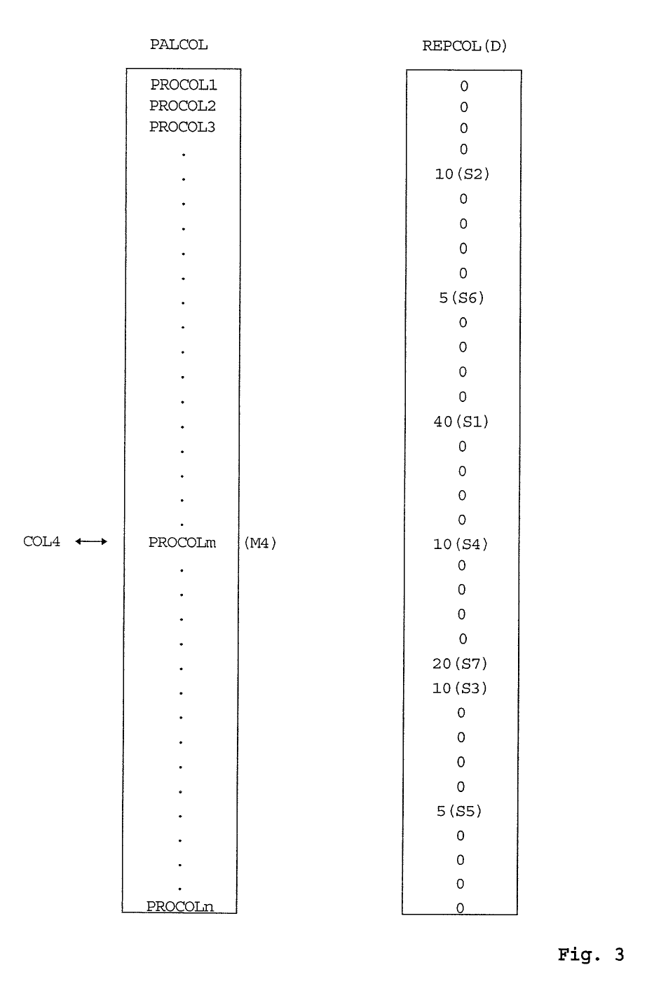

FIG. 3 shows a vector corresponding to the table of FIG. 2.

The present invention implies two groups of users of the method: a group of operators and a group of explorers. The group of operators is formed of a small number of individuals capable of implementing by computer means a preparatory phase intended for properly organizing the database. An operator works on a computer (of standard PC type, for example) in direct communication with the multimedia database installed on a hard disk. The group of explorers can be formed of thousands of Net surfers having no familiarity with the methodologies of the preparatory phase and having no knowledge of the method other than that which will be communicated to them on line by the web pages of the Internet site for which the present invention has been implemented.

1. Content Driven Organization of the Database

1.1 Off-line Preparation of the Database by an Operator

According to a first aspect of the present invention, a phase of preparation of a database is provided. This preparatory phase, started by an “operator”, takes place after the installation of a computer multimedia database on the hard disks of a computer server, by means of a standard database management software (such as ORACLE).

The object of this computing time consuming, off-line preparatory phase, essentially is the automatic generation of a family of “hyperlink tables”, enabling very fast association, with each document D of the multimedia database, of a list VPREF(D) of the preferential neighbors of D: VPREF(D)=(D1, D2, D3 . . . Dr).

List VPREF(D) contains the names of documents (D1, D2, D3 . . . Dr), the semantic or graphic contents and/or the aspect of which are close to those of D. Size r of this list can depend on document D. List VPREF(D) is organized by degree of decreasing closeness to the initial document D, D1 being the closest to D, D2 being the document other than D1 which is closest to D, and so on. The notion of closeness used herein is quantified by adequate “distances”, and there are thus as many hyperlink tables as there are such distances. In the effective computer implementation of the present invention, each document name is accompanied, of course, by its address on the hard disks of the server of the multimedia database. Each of the “hyperlink tables” hereabove thus contains as many lists as there are documents in the multimedia database, and these tables are stored on the multimedia database server, for example under a database management system of ORACLE type.

Automatic Generation of the “Hyperlink Tables”

The present invention provides the automatic generation of the hyperlink tables, stored on a hard disk, in a “hyperlink base”, managed for example with ORACLE.

To electronically index all the images in the database, the operator specifies his choice of “technical characteristics” of the database elements. For an image, or for a region within an image, a first technical characteristic may be the color, a second technical characteristic may be the texture, a third technical characteristic may be the silhouette, a fourth technical feature may be the semantic content of a text associated with the image.

For each technical characteristic, a specific calculation mode is defined to evaluate a “distance” numerically representing the difference between two images, as regards the considered characteristic.

For each image D of the multimedia database, an ordered list VOISCAR(D) of the neighbors of D for the considered characteristic is first built:

VOISCAR(D)=(D1, D2, D3 . . . Dm)

where D1 is the image closest to image D, where D2 is the image closest to image D other than image D1, and so on. In other words, the neighbors of D are arranged by increasing order of distances from image D. Size m of list VOISCAR(D) can depend on document D, since the present invention provides two restrictions on this size:

(a) it is imposed for m to be smaller than a determined integer, chosen by the operator,

(b) it is imposed for all neighbors Dj of D to be at a distance from D smaller than a determined numerical threshold, chosen by the operator.

This procedure is clearly computerizable and is thus started, off-line, on all images D of the multimedia database, to provide all the lists of neighbors VOISCAR(D). This set of lists VOISCAR(D) forms a first table of hyperlinks, which will be stored on a hard disk, in a hyperlink base, for example in ORACLE. The number of hyperlink tables associated with the images, equal to the number of technical characteristics retained to prepare the database, will generally range between 2 and 6.

Specification of a Preferential Multimedia Browsing Scheme

The aim of this step is to specify a mode of calculation of the preferential neighbors VPREF(D) for any image D in the database. The operator must here specify a preference scheme in the multimedia database, which scheme will more or less strongly favor certain features in the fast comparison of images.

Note s the number of retained specified technical characteristics CARj, 1≦j≦s. For any image D, a list of neighbors VOISCARj(D) associated with characteristic CARj can be read from each of the hyperlink tables hereabove.

The operator will here specify a precise selection mode, enabling extraction from the set of all neighborhoods VOISCARj(D), 1≦j≦s, of a list PREF(D) of preferential neighbors of D, arranged by decreasing preferences.

Many practical alternatives to this selection mode may be envisaged within the framework of the present invention. A parameterizable alternative of this selection mode will be described. The operator specifies for each characteristic a positive “significance coefficient” designated by “Wj”, 1≦j≦s. The limitation of only considering neighbors of D, that is, images “A” belonging to at least one of neighborhoods VOISCARj(D) is a natural preliminary restriction.

Let us set such an image “A” and let “Nj” be its rank in list VOISCARj(D) if A is in this list. If A is not in list VOISCARj, let us state Nj=b, where integer b is a large enough number determined by the operator. Average Q of the s numbers (Wj.logNj) can then be calculated, and an “average rank” RM(A) can be defined for image “A” hereabove, by formula logRM(A)=Q. The neighbors of image D can then be arranged by increasing value of the “average rank” RM defined hereabove.

The operator then chooses a fixed integer, and selects all the neighbors of D having an “average rank” smaller than this number. This ordered family of images will form the set of preferential neighbors VPREF(D).

Once the selection mode has been determined by the operator, it is possible to start off-line the systematic calculation of all lists of preferential neighbors VPREF(D), for all the images D in the database, and to store on a hard disk all these results in the form of a new hyperlink table.

Another interesting approach, in another alternative of the present invention, consists of changing during operation the selection mode to be implemented, for example to take account of specificities linked to some preferences already known by the Net surfer having sent the request relative to document D.

1.2 Content Driven Browsing on an Internet Site

After having connected himself to the Internet site, from any computer provided with a standard browser such as Netscape or Internet Explorer, the Net surfer user has access in a standard manner to a “web page” of the site enabling display of a first document D of the database prepared as hereabove.

In the context of the present invention, using standard computer programs (implementable by HTML pages and Javascript codes, for example), the Net surfer triggers, by mouse-clicking on the displayed document, the automatic transmission of an implicit request to the web server of the Internet site. The content of the implicit request thus transmitted is the request for list VPREF(D) of the preferential neighbors of D. It should be noted that this request can remain totally implicit, and thus totally transparent for the Net surfer.

Using standard computer softwares (implementable for example in Java language by means of “Enterprise Java Beans” softwares and by programming of SQL requests), the content of the above implicit request successively triggers, on the multimedia database server, a sequence of computer operations:

(a) fast access to the hyperlink tables,

(b) reading of list D1, D2, D3, . . . Dr of the preferential neighbors of D,

(c) retransmission to the web server of software objects (for example structured by means of XML codings) describing the contents and formats of documents D1 to Dr, or the contents and formats of icons, labels, texts, etc. representing these documents,

(d) retransmission to the Net surfer's computer of the above software objects, which will be exploited on-line by an adequate program (for example by means of a parser written in Javascript language) enabling simultaneous or sequential display on the Net surfer's screen of documents D1 to Dr, or icons, labels, texts, etc. representing these documents.

The Net surfer user, having seen the lists of the documents, labels, icons presenting the possible responses to his implicit request, can then trigger by standard computer means the full page display, or the dynamic inspection on his screen, of any one of these documents. The content driven browsing cycle can now be resumed by mouse-clicking from this new document, exactly as described for the preceding document.

2. Preparation of an Image database

According to a second aspect of the present invention, methods for analyzing and structuring a document base according to the selected technical characteristics are provided. For image databases, the following technical characteristics will be presented among others: color, texture, silhouette.

For each technical characteristic that the operator has decided to use, and for which he has specified a computerizable calculation method, the operator must then specify a computerizable method to calculate a numerical “distance” for this characteristic between any two documents.

The present invention provides extraction methods for these technical characteristics, so that they can be represented in the form of vectors with numerical coordinates, the dimension of which is determined or self-adjusted. This point is a significant advantage for the massive and fast computer implementation of the present invention.

After the specifications of the technical characteristics and of their computation modes, the operator starts, for all non-text documents of the multimedia database, the systematic intensive computation and the storage (on a hard disk) of the values of their technical characteristics.

These massive off-line computations create a base of computed technical characteristics, which base is intended for being stored on a hard disk, for example with Oracle software tools, the values of the technical characteristics of all the documents in the database, the values of the distances between arbitrary pairs of documents, and the list of the closest neighbors of each document, for each characteristic and possibly for a weighted combination of characteristics.

This is an intensive automatic computation step, the duration of which depends on the size of the database, and which has the advantage, according to the present invention, of being implementable off-line.

2.1 Color Characteristic

As a first example, a way of structuring in a precise comparative manner a base of images based on their colors will be considered, that is, the considered technical characteristic is a color characteristic.

Several computing methods enable associating to each light point or pixel of a digitized image D a vector of dimension 3 characterizing the “color” of this pixel, in Red/Green/Blue coordinates or in LUT coordinates, etc.

Since an image or a shape includes hundreds of thousands of pixels, it is necessary to summarize the preceding vectorial data. For this purpose, one of the many known computer segmentation methods is applied to automatically cut up image or shape D into a reasonable number of connective regions R1, R2 Rk, each of these regions being approximately homogenous in terms of color.

As an example, this is very schematically illustrated in FIG. 1 where an image 1 is divided up into seven regions of homogenous colors R1 to R7, it being understood that, in practice, number k of regions is much higher but is chosen to be lower than a fixed number such as one hundred for a given image.

A possible alternative, which is faster but less precise, consists of setting for regions R1, . . . Rk a small number of rectangular sub-images arranged in a regular paving to cover the initial image D.

Once this cutting-up has been performed, for any integer j such that 1≦j≦k, ratio Sj of the surface area of region Rj on the surface area of image D, and average COLj of the values of the color vectors of the pixels of region Rj are successively calculated.

It will be possible to calculate the “color distribution” of image D based on lists COL(D) and SURF(D):

COL(D)=(COL1, COL2, . . . COLk), and

SURF(D)=(S1, S2 . . . Sk).

FIG. 2 illustrates an example of these lists.

It should be noted that integer k can vary from one image to the other.

The hundreds of thousands of color vectors associated with the pixels of a same image belong to a space of dimension 3. Numerical distances between can be calculated between two color vectors by using calculation formulas such as the Euclidean distance for the Red/Green/Blue coordinates.

The present invention consists of now automatically creating a “color look-up table”, designated as PALCOL, which is well adapted to a methodical description of all the colors of all the images in the database. For example, by dividing up in a sufficiently fine way all the possible values for each of the 3 color coordinates, one creates a regular network of n “prototype” color vectors PROCOL, network which can be described by an ordered list PALCOL:

PALCOL=(PROCOL1, PROCOL2, PROCOL3 . . . PROCOLn),

so that any observed color vector is very close to at least one of the color prototypes PROCOLj. In practice, values of n ranging between a few thousands and a few hundreds of thousands are sufficient.

A more effective alternative to calculate PALCOL is to apply one of the many known public “dynamic cloud” algorithms to all the color vectors of dimension 3 observed over all the database images, which enables automatic partitioning of this cloud of colors vectors into n color sub-groups or clusters, each cluster being formed of colors very close to one another. The prototype colors PROCOLj then are the “centers” of these color clusters.

For an image D, each color vector COLj listed in COL(D) is present with a frequency Sj listed in SURF(D); the color prototype PROCOLm closest to COLj has a rank m=Mj in the ordered prototype list. When j varies from 1 to k, this provides a non-ordered list G of k distinct integers, G=(M1, M2 . . . Mk).

For any integer i, 1≦i≦n, define

RCi=0 if i is not in list G,

RCi=Sj, if i is in list G and is equal to Mj.

The color distribution of image D will be the following vector REPCOL(D), of dimension n:

REPCOL(D)=(RC1, RC2, RC3 . . . RCn).

Color distributions REPCOL(D) thus are vectors belonging to a vector space of dimension n. Each of the coordinates of such a vector corresponds to one of the colors of color look-up table PALCOL and indicates with what frequency this color is present on image D.

This is very schematically illustrated in FIG. 3 in which color look-up table PALCOL including elementary colors PROCOL1 . . . PROCOLn has been shown. In relation with the example of FIGS. 1 and 2, it has been indicated that color COL4 of region R4 is particularly close to prototype color PROCOLM. This is also done for all colors COL1 to COL7 of regions R1 to R7 of image D of FIG. 1.

Color distribution vector REPCOL(D) of the image can then be reconstructed, in which the value of each coordinate of the color look-up table is replaced with the relative surface area of the region having the closest average color to the color corresponding to this coordinate.

Based on vectors REPCOL(D), the “distance” between any two images v and w can be determined.

Note Bij the square of the numerical distance between two color prototypes PROCOLi and PROCOLj. In particular, Bii will represent the square of the “length” of PROCOLi. Define numbers Kij, representing the scalar product of vectors (of dimension 3) PROCOLi and PROCOLj, by the following formula:

2Kij=Bii+Bjj−Bij.

Take any two “color distributions” Y and Z, and respectively note Y1, Y2 . . . Yn the coordinates of Y and Z1, Z2 . . . Zn the coordinates of Z. Square DELTA of the “distance” between two color distributions Y and Z will be defined as:

DELTA=Sum of (Kij×Yi×Zj), for 1≦i, j≦n.

The distance between two images has thus been determined. Based on these distances, it will then be possible, for each image and for the color characteristic, to establish the list of the closest neighbors to this image D. This list can be used in accordance to what has been described at point 1.1 of the present description.

2.2 Texture Characteristic

As a second example, a way of classifying the images by their texture will be considered, that is, the considered technical characteristic is a texture characteristic.

Several computing methods enable associating with each pixel P of a digitized image D a vector WP of high enough dimension t characterizing the “texture” of this pixel. The texture vector can for example be calculated by known wavelet analysis or fast Fourier analysis methods, etc.; dimension t of the texture vector typically ranges between 32 and 1024.

Since an image frequently contains hundreds of thousands of pixels, it is necessary to summarize the hundreds of thousands of preceding texture data. For this purpose, one of the many known computer segmentation methods can be applied to automatically cut up image D into a reduced number of connective regions R1, R2 . . . Rp, each of these regions Rj being approximately homogenous as concerns the texture. Typically, number p of regions does not exceed one hundred for a given image.

Another faster and less precise possible alternative consists of determining for regions R1 . . . Rp a small number of rectangular sub-images arranged in a regular paving to cover the initial image or shape D.

For each integer j, 1≦j≦p, ratio Sj of the surface area of region Rj on the surface area of image or shape D and average TEXj of texture vector WP when pixel P covers region Rj area calculated.

It will be possible to calculate the “texture distribution” of image D based on lists TEX(D) and SURF(D):

TEX(D)=(TEX1, TEX2 . . . TEXp), and

SURF(D)=(S1, S2 . . . Sp).

Integer p can vary from one image to the other.

The hundreds of thousands of texture vectors associated with all the pixels in a same image belong to a texture space of dimension t. Numerical differences between two textures can be calculated by using calculation formulas such as the Euclidean distance.

By applying a compression method, such as for example the principal component analysis of all the “texture” vectors observed over all the images in the multimedia database, the effective dimension of the texture space is first reduced to a value s smaller than t.

The present invention provides automatically creating a texture look-up table designated as PALTEX, which is well adapted to a methodical description of all the textures of all the images in the database. For example, by dividing up in a sufficiently fine manner the set of all possible values for each of the s compressed coordinates of the texture space, one can create a regular network of m “prototype” texture vectors that can be grouped in an ordered list:

PALTEX=(PROTEX1, PROTEX2, PROTEX3, . . . PROTEXm),

so that any texture vector is very close to at least one of the texture prototypes PROTEXj. In practice, values of m ranging between a few thousands and a few tens of thousands are sufficient.

For an image D, each texture vector TEXj listed in TEX(D) is present in image D with a frequency Sj listed in SURF (D); the texture prototype PROTEXr closest to TEXj has a number r=Nj in texture look-up table PALTEX. When j varies from 1 to p, this provides a non-ordered list H of p distinct integers:

H=(N1, N2, . . . Np).

For any integer i, 1≦i≦m, let us then set:

RTi=0 if i is not in list H,

RTi=Sj if i is in list H and is equal to Nj.

The “texture distribution” of image D will be the following vector REPTEX(D), of dimension n:

REPTEX(D)=(REPTEX1, REPTEX2, REPTEX3 . . . REPTEXn).

“Texture distributions” REPTEX(D) thus are vectors belonging to a vector space of dimension n. Each of the coordinates of such a vector corresponds to one of the textures of texture look-up table PALTEX, and indicates with what frequency this texture is present on image D.

A mode of distance calculation between any two texture distributions v and w will be specified. Call Gij the square of the numerical difference between two texture prototypes PROTEXi and PROTEXj. In particular, Gii will represent the square of the “length” of PROTEXi. Let us define numbers Lij, representing the scalar product between two texture prototypes PROTEXi and PROTEXj, which thus are two vectors of dimension s, by the following formula:

2×Lij=Gii+Gjj−Gij.

Take any two “texture distribution” vectors Y and Z, and respectively call Y1, Y2 . . . Ym the coordinates of Y, and Z1, Z2 . . . Zm the coordinates of Z. Square GAMMA of the distance between Y and Z will be defined by:

GAMMA=Sum of (Lij×Yi×Zj) for 1≦i, j≦m.

2.3 Silhouette Characteristic

As a third example, a way of classifying the images by the silhouettes that they contain will be considered, that is, the considered technical characteristic is a silhouette characteristic.

The “silhouette” of a shape F is a computer coding of the closed line defining the external contour of this shape. Conventionally, an approximation of such an external contour is made by a polygon SIL(F) having a sufficient number r of vertices, and is stored in the form of a pixel sequence:

SIL (F)=(P1, P2, P3 . . . Pr)

where each pixel is located by its abscissa and its ordinate in the image.

When F describes all the shapes identified in the image database, the corresponding set of silhouette vectors SIL (F) forms a “cloud of points” in a vector space of dimension 2r.

Numerical variations between two silhouettes can be defined by using explicit calculation formulas, which will provide a numerical measurement of the difference between any two silhouettes SIL(F) and SIL(F′).

By applying for example one of the known “dynamic cloud” methods, all the silhouettes identified over all the images in the database can be divided into q silhouette clusters, all silhouettes in a same cluster being very close to one another, and the silhouettes at the “center” of these clusters can be identified.

The present invention consists of considering all these cluster center silhouettes as a family of “silhouette prototypes” that can be gathered in an ordered list PALSIL of q silhouette prototypes, which list is here called a “silhouette look-up table”:

PALSIL=(PROSIL1, PROSIL2, PROSIL3 . . . PROSILq).

Any silhouette vector will then be very close to at least one of the silhouette prototypes.

The “silhouette characteristic” SIL(F) of shape F will be systematically replaced with the silhouette prototype which is closest to the initial silhouette vector of F.

In the context of the present invention, for each image D of the database, a list of shapes present on image D is identified by any computerizable method, supervised or not (such as an automatic image segmentation, a methodical search from a first bank of shapes, etc.).

The set of the shapes (F1, F2 . . . Fr) identified on a same image D can then be described by a single vector of dimension q, designated as GRAPH(D), and representing the graphic content of image D.

Coordinates GRj of vector GRAPH(D)=(GR1, GR2 . . . GRq) for j varying from 1 to q are calculated as follows:

GRj=1/q if silhouette prototype PROSILj is equal to one of silhouettes SIL(F1), SIL(F2) . . . SIL(Fr),

GRj=0 in all other cases.

All the graphic contents GRAPH(D) associated with all images D of the database belong to the vectorial space (of dimension q) of the graphic contents. A distance between graphic contents of two images D and D′ can thus be defined quite similarly to that used in sections 2.1 and 2.3 (see formulas DELTA and/or GAMMA).

2.4 Other Characteristics—Semantic Characteristics

In other alternatives of the present invention, some of the above technical characteristics may be suppressed, just as many other technical characteristics of images or shapes may be specified and taken into account, according to analogous implementation schemes, such as for example:

the “connectivity graph” making an inventory of all the pairs of contiguous regions in the division into regions R1, R2 . . . Rk provided by automatic segmentation,

the responses to certain space filters intended for spotting the points of strong local contrast,

the positions of angles or corners, etc.,

the distributions of “contours” detected on the image by contour detectors,

etc.

Further, to each document D which is not of “text” type, it is possible to append a non-structured text written in a totally free mode, containing a few words, groups of words, lines, sentences, or paragraphs, and forming a rough explanatory sheet of the major information contained in document D.

This explanatory text can be either a text specifically written by a researcher, or a more informal text directly or indirectly alluding to the content of document D.

As an example:

if D is the image of an objet d′art, the appended text can be a museum note or an explanatory note about its author and origin, or merely the title of a painting, etc.

if D is a picture extracted from an electronic magazine, the appended text can be a mere caption, or an article extract accompanying the picture, etc.

This type of appended text can, in a first alternative of the method, be directly extracted from the multimedia database by the operator using the present method, who, having seen document D, will then simply select from the existing text base and on a standard computer interface the text document that he desires as an appended text, then store the address of this text in a look-up table memorized on a hard disk.

A standard computer interface enabling the operator to input on his computer, by keyboard typing, the texts appended to all the documents in the multimedia database (or to one part only of these documents) may also be provided. In the approach of longer duration, the appended texts will generally be short and can even be limited to a few words.

In an alternative method, applicable to some classes of documents D of video type of or sound recording type, the operator can implement a computer program automatically transcribing in the form of a text T the voice recording appearing on the sound track of video D, or appearing on sound recording D. Available software dedicated to this task (like IBM's dictating machines) start emerging for English and French, but are often technically confined to single-speaker speech with no musical background and no parasitic noise.

Existing text search engines enable associating with any text T a vector (generally of large dimension) V(T), enabling approximate coding of the semantic content of text T.

Similarly, many computerizable procedures have been suggested to calculate a numerical distance DIS(T, T′) quantitatively measuring the difference between the semantic contents of two texts T and T′, distance which can be directly calculated from V(T) and V(T′).

Let us select any one of these procedures enabling calculation of V(T) and of DIS(T, T′). For any document D which is not of text type, the operator, starting from the text appended to D and designated as txtD, can define a semantic content characteristic SEM(D) of non-text document D by SEM(D)=V(txtD). Distance DISSEM between the semantic characteristics of any two documents D and D′ can then be calculated by formula DIS(txtD, txtD′).

This semantic characteristic SEM(D) can be added to the technical characteristics already discussed hereabove, and in particular cause the creation of a table of semantic hyperlinks TABSEM, gathering for each document D the ordered list VOISEM(D) of its closest “semantic neighbors”.

The semantic characteristic can thus be integrated in the preferential multicriteria browsing schemes discussed hereabove, which for example enables crossing the effect of the graphic criteria and of the semantic criteria.

3. Other Databases

3.1 Video

A sequence of video images will be divided up in an automated or interactive way into “sequence shots”. The image family F(D)=(J1, J2, . . . Js) gathering the initial images J1 to Js of all these sequence shots forms a natural summary of video D. It should be noted that integer s can depend on video D.

These image families will be processed similarly to what has been discussed in section 2.

3.2 Sound Documents

According to an aspect of the present invention, a representation of “spectrogram image” type, which consists of partitioning any sound recording D into n very short consecutive fragments of equal duration (generally less than one second) is first calculated for any digitized sound document D, which fragments are designated as:

FRAG1, FRAG2, FRAG3 . . . FRAGn,

after which the fast Fourier transform (FFT) of each fragment is calculated, which provides a sequence of vectors:

FFT1, FFT2, FFT3, . . . FFTn.

All these vectors FFTj are of same dimension q, which number is generally equal to one of integers 16, 32, 64, 128, 256, 512. Number q indicates that the general range of audible frequencies has been divided by the operator using the method into q consecutive frequency bands numbered from 1 to q, according to an arithmetic or logarithmic scale, according to one's preferences.

Coordinate number k of vector FFTj then represents the spectrum power Ejk of sound fragment FRAGj in frequency band number k.

The table of numbers Ejk, where j varies from 1 to n and k varies from 1 to q, can be graphically represented by a synthetic image where the light intensity of the pixel of coordinates j and k is equal to Ejk. This “spectrogram image” thus has a number of pixels equal to n×k.

The present invention then provides systematically applying all the techniques indicated hereabove in the case of images to automatically calculate corresponding technical content characteristics for sound documents.

The operator using the method specifies a simplified notion of “sound color” by dividing the range of spectrum powers into a small number h of consecutive numerical intervals (L1, L2, L3 . . . Lh).

A pixel of the spectrogram image will be said to be of sound color number i if its light intensity has a value belonging to interval Li.

In an alternative of the present invention, the dividing of the image into homogenous areas of same sound color and the optimal choice of the intervals (L1, L2, L3 . . . Lh) may be performed automatically by any of the existing methods of computer image segmentation.

The method described hereabove in sections 2.1 in the case of ordinary digital images then provides for each spectrogram image a “color distribution”, which will be called a “sound color distribution” of sound document D, and also provides the calculation mode of the distance between two sound color distributions.

The method described in section 2.2. provides for each spectrogram image a texture distribution, which will be called a “sound texture distribution” of sound document D, and thus provides the calculation mode of the distance between two sound texture distributions.

Finally, the method described in section 2.3 enables defining for each sound document D a graphic content vector associated with spectrogram image J=IMSPECT(D), the “shapes” present in J being determined by automatic segmentation in homogenous regions as regards sound colors.

The method of section 2 also provides a mode of calculation of the distance between the “graphic contents” of two sound documents.

In an alternative of the present invention, the initial processing of fragments FRAGj of the sound document by fast Fourier transform may be replaced with transformations on wavelet bases, which will associate with each fragment FRAGj a vector WWj, quite similar to vector FFTj introduced hereabove. The rest of the procedure unwinds in an analogous way.

4. Alternatives

Of course, the present invention is likely to have various alternatives and modifications which will occur to those skilled in the art.

In particular, the operator may select and store on screen adequate sub-documents, by means of an appropriate man-machine interface, implementable for example with Director, or in Java code, etc.

The principle is the following: the operator examines a document on screen (image visualizing, video scrolling, sound document listening), then selects by mouse-clicking the document portions of interest to him, such as regions of an image, a video sequence shot, a continuous fragment of a sound recording, etc. These choices of the operator are stored in a standard way in the initial multimedia database, to thus create an extended multimedia database where the document portions thus defined have the status of documents in their own right and play exactly the same role as the initial documents in the multimedia database.

The sub-documents of an image can be any regions of the image, circumscribed on screen by a polygonal line (or by a continuous curve) drawn with the mouse by the user. Generally, the operator will select semantically significant regions (figures, buildings, etc.).

The sub-documents of a video will either be “sequence shots” (video portions where no abrupt change of camera angle occurs), or isolated images extracted from the video, for example “sequence shot change” images.

During the listening of a computerized sound recording, a standard man-machine interface can enable the operator to mark by mouse clicking the beginning and the end of the “continuous sound fragments” of interest to him.

Further, the methods for computing vector forms for various technical characteristics of an image are likely to have various alternatives which will occur to those skilled in the art.

1. A method of content driven browsing in a database including a large number of documents (D), that can be broken up into elements (R1 to Rk), each element being described by a state or a value of a same technical characteristic, including the steps of:
a) analyzing the general distribution of the values taken by said technical characteristic over all elements of all documents of the database, to form a sufficiently representative family, which is however of reduced size, of prototype values for said technical characteristic;
b) forming from each document of the database a vector, each coordinate of which corresponds to a prototype value of said characteristic, the value of each coordinate of the vector corresponding to the frequency of occurrence of said prototype value in the document;
c) determining the distances between arbitrary pairs of vectors associated to the various documents of the database; and
d) associating with each document a list of the closest documents for said characteristic.

2. The method of claim 1, characterized in that steps a) to d) are repeated for various technical characteristics that can be associated with the documents of the database and, with each document are associated several lists of the closest documents, each list corresponding to one of said characteristics.

3. The method of claim 2, characterized in that it includes the step of forming a list of the closest documents, resulting from a weighted combination of the lists corresponding to the various characteristics.

4. The method of claim 1, characterized in that the documents are images and the forming of said vector REPCOL(D) includes the steps of:
breaking up each image into a number k of regions (R1 to Rk) homogenous as regards said characteristic and for which the mean value (COL1 to COLk) of said characteristic is determined;
determining the relative surface area (S1 to Sk) of each homogenous region;
creating a look-up table of n prototype values (n≧k) of said characteristic sufficiently close to all the observed mean values;
determining for each mean value (COLj) of each image the number (Mj) of the closest prototype value;
stating G=(M1, M2 . . . Mk);
constructing a vector REPCOL(D)=(RC1 . . . RCn) such that RCi=0 if i does not belong to G and RCi=Sj if i belongs to G and is equal to Mj.

5. The method of claim 4, characterized in that the characteristics are colors, and said regions (R1 to Rk) have homogenous colors (COL1 to COLk).

6. The method of claim 4, characterized in that the characteristics are textures, and said regions (R1 to Rk) have homogenous textures (TEX1 to TEXk).

7. The method of claim 4, characterized in that the characteristics are shapes, and said regions (R1 to Rk) have as shape characteristics their external contours, or silhouettes, (SIL1 to SILk).
